(19) United States
(12) Patent Application Publication
(10) Pub. No.: US 2003/0223802 A1
(43) Pub. Date: Dec. 4, 2003

(54) Safe products for prisoners using non-reformable materials

(76) Inventors: Paul J. Biermann, Columbia, MD (US); Gary E. Peck, Baltimore, MD (US)

Correspondence Address: Benjamin Y. Roca, Office of Patent Counsel, The Johns Hopkins University/, Applied Physics Laboratory, 11100 Johns Hopkins Road, Laurel, MD, 20723-6099, US

(21) Appl. No.: 10/452,896

(22) Filed: Jun. 2, 2003

Related U.S. Application Data
(60) Provisional application No. 60/385,001, filed on Jun. 3, 2002.

(51) Int. Cl. A46B 5/00; A46B 9/04; B43K 19/00

(52) U.S. Cl. 401/49; 15/143.1; 15/167.1

(57) ABSTRACT

An implement for use in prison environments which is not reformable into a weapon and including at least a body having a proximal handle portion and a distal operational portion is provided. The body is non-sharpenable and fabricated from a non-meltable material, and has frangible means for limiting body strength by facilitating structural failure of the body upon application thereto of a force exceeding a predetermined magnitude.

### CROSS-REFERENCE TO RELATED APPLICATIONS

This application claims the benefit of Provisional Application No. 60/385,001 filed Jun. 3, 2002, the contents of which are incorporated herein by reference.

### BACKGROUND OF THE INVENTION

1. Field of the Invention

The present invention generally relates to hand-held implements such as articles for personal hygiene, e.g., toiletry articles, communication and eating. More particularly, the present invention is directed to hand-held implements formed from non-sharpenable and non-meltable materials for use by prison inmates.

2. Description of the Relation Art

Hand-held articles such as, for example, toothbrushes, safety razors, writing implements, eating implements and the like, can be modified by an individual so as to be reformed into weapons. For example, the plastic body of a toothbrush can be melted, remolded and sharpened to produce a pointed or edged weapon. Another example is that the blade of a safety razor can be extracted and attached to a slot formed in a plastic handle to likewise produce a pointed or edged weapon. Eating implements such as plastic utensils can also be modified to produce weapons.

This creates a potentially dangerous situation when, for example, a prison inmate reforms a hand-held article into a weapon for use against a prison guard(s) or another inmate(s). Consequently, it would be advantageous to have a hand-held article which can be used by the inmates without the danger of being reformed into a weapon.

### SUMMARY OF THE INVENTION

It is, therefore, an object of the present invention to provide an implement which is not capable of being reformed into a weapon. The implement of the present invention comprises a body having a proximal handle portion and a distal operational portion, the body being non-sharpenable and fabricated from a non-meltable material, and having frangible means for limiting body strength by facilitating structural failure of the body upon application thereto of a force exceeding a predetermined magnitude. The implement can advantageously be used, for example, in prison environments to prevent injury to the correctional facility staff and inmates caused by the unauthorized fabrication of weapons from commonly used implements and utensils.

### BRIEF DESCRIPTION OF THE DRAWINGS

Various embodiments are described below with reference to the drawings wherein:

FIG. 1 is a sectional view of a toothbrush embodiment of the invention;

FIG. 2 is a sectional view of another toothbrush embodiment of the invention;

FIG. 3 is a sectional view of yet another toothbrush embodiment of the invention;

FIG. 4 is another sectional view of the toothbrush embodiment of FIG. 3; and

FIGS. 5, 6, and 7 are perspective views of, respectively, a safety razor, writing implement, and eating utensil which in accordance with the implement of the present invention.

### DESCRIPTION OF THE PREFERRED EMBODIMENTS

The invention herein relates to hand-held implements, particularly those used for personal hygiene, communication, eating, and the like. Such implements typically have a body with a proximal handle portion and a distal operational portion, or a “head” portion. The distal operational portion typically supports some operating feature of the implement. For example, the distal operational portion, or head, of a toothbrush supports the bristles used to brush the teeth. The distal head portion of a safety razor type shaving implement supports a blade for shaving. The distal head of a writing implement supports a nib, or other such means to apply ink, graphite or other writing medium to a writing surface. The distal operating portion of an eating utensil provides means to grasp, cut or contain comestibles. The body of the implement of the present invention is substantially non-sharpenable, i.e., it will not form an edge. Also, the body is made from non-meltable material, so it cannot be reformed (e.g., by heating the body to temperature that will allow the body to reformed). Furthermore, the body includes frangible means to limit the strength of the implement body so that it will not penetrate the skin of a human. The frangible means cause structural failure of the body if a force is applied to it which exceeds a predetermined magnitude. That is, the body of the implement is constructed so as to be strong enough to perform the intended function of the implement (e.g., brushing one's teeth, shaving, writing, eating, etc.), but weak enough to break if used as a weapon to strike a person, or if manipulated in an attempt to reform the body to hold a sharpened piece of material, e.g., such as attempting to form a slot in the body to hold a razor blade or other metal strip having a sharpened edge.

The present invention is described below with respect to toothbrushes. However, it should be recognized that other hand-held implements such as, for example, safety razors, writing implements (e.g., pens, pencils), eating implements (e.g., knives, forks, spoons), and other such implements can be fabricated in accordance with the methods and materials described below, and are also within the scope of the invention.

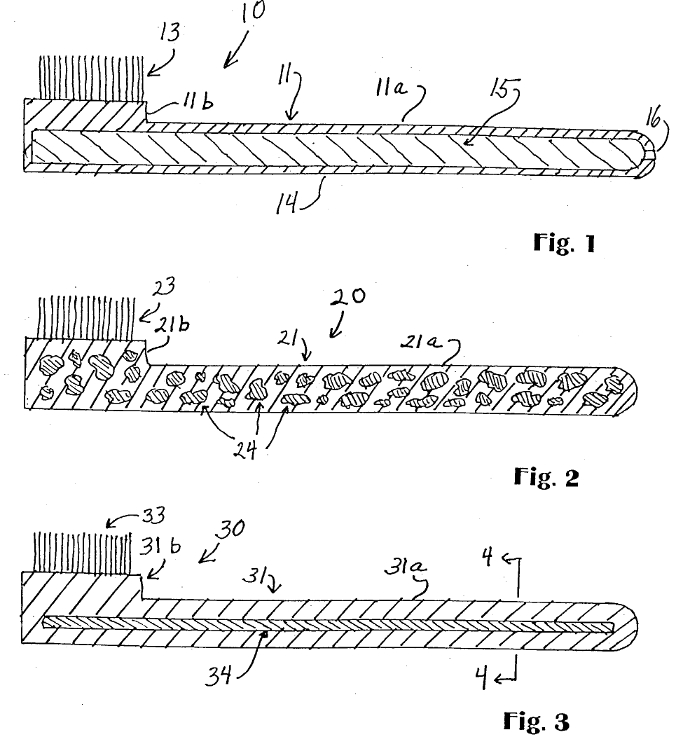

Referring now to FIG. 1, a toothbrush 10 includes a body 11 having an elongated proximal handle portion 11a and a distal head portion 11b. Bristles 13 are attached to the head portion 11b. The body has a thin outer wall, or shell, 14, which defines an interior space 15. Optionally, a valve 16 may be incorporated into the proximal end of the body 11.

The body 11 is preferably fabricated from a non-meltable material such as, for example, a thermoset resin material, to preclude the possibility of reshaping the body by remelting and remolding or otherwise reforming the body 11 into a configuration which can be used as a weapon. A wide array of thermoset materials can be utilized in forming the implement of the present invention. Suitable thermoset materials include, but are not limited to, thermoset polymeric resins such as, for example, epoxy resins, melamine resins, phenolic resins, urea-formaldehyde resins, phenol-formaldehyde resins (e.g., Bakelite®), polyurethanes, polyimides, polyureas, hard or soft rubbers, e.g., butadiene, silicone, or any natural or synthetic elastomer, or virtually any irreversibly cross-linked resin system including allyl resins such as diallyl phthalate and diallyl isophthalate, cyanate ester resins, unsaturated polyesters such as orthophthalic, isophthalic, BPA fumarate and chlorendic resins, bismaleimide, vinyl esters, and combinations of the above, all of which are known and commonly available.

The interior space 15, can optionally be filled with a loose, inert particulate filler material such as, for example, ground walnut shells, cork, salt, dried clay, or thermoset polymers (such as those listed above) in particulate form except for rubbers, low durometer urethanes and other easily compressible material, and also preferably drawn under vacuum. In this embodiment, the external air pressure pushes the shell 14 against the vacuum packed particulate filler, thereby imparting rigidity to the handle portion 11a. If the shell 14 is broken, or if the vacuum is lost through leaks or diffusion of air into the interior space 15, the rigidity would be lost. The toothbrush would be useless if the outer wall 14 were to be cut or abraded in an attempt to reform it. Valve 16 at the proximal end of the toothbrush is preferably a one-way valve and facilitates access to the interior space 15 so that a vacuum or higher pressure can be established. Valves suitable for use in the invention are known to those with skill in the art. In one method of use, the prison inmate would have to connect the valve for each of the toothbrush with, for example, a vacuum pump, to remove the air and make the toothbrush rigid for a period of time sufficient for its use after which natural leakage would cause the toothbrush to become flaccid. The interior space 15 can alternatively be filled with a fluid such as a liquid (e.g., water) or gas (e.g., air, CO₂), optionally under pressure, e.g., a pressure ranging from about 15 psig to about 30 psig. Also, the interior space 15 can be filled with a soft, flexible rubber.

The thickness of exterior wall 14 is selected to provide sufficient strength for the intended low impact use of brushing teeth, but which is frangible under heavy stress, such as would occur if the user attempted to employ the toothbrush as a weapon to strike another person. In such an event the toothbrush would break under the stress. Typically, for a toothbrush the handle portion 11a can have a diameter ranging from about 3/8 inches to about 1 inch, and the exterior wall 14 can have a thickness ranging from about 0.003 inches to about 0.100 inches. These ranges are given for purposes of exemplification. Dimensions outside these ranges can be used when appropriate.

Referring now to FIG. 2, a toothbrush 20 includes a body 21 having an elongated proximal handle portion 21a and a distal head portion 21b to which bristles 23 are attached. Body 21 is preferably fabricated from the foregoing thermoset resins and can include relatively large size filler particles 24 of a frangible or soft material such as mica, calcium carbonate, graphite, low durometer polyurethanes (polyisocyanates), hard or soft rubbers (e.g., butadiene) or any natural or synthetic elastomer (e.g., silicone), or hollow thermosetting polymer spheres. The particles 24 advantageously prevent the body from being sharpened or slotted. Moreover, the particles 24 make body 21 more frangible so that a stress greater than the anticipated stresses of brushing one's teeth would cause the body 21 to break. For a toothbrush having a handle ranging in diameter of from about 3/8 inches to about 1.0 inch, the particles typically can range in average diameter of from about 0.10 inches to about 0.25 inches, although diameters outside of these ranges can be used whenever deemed appropriate.

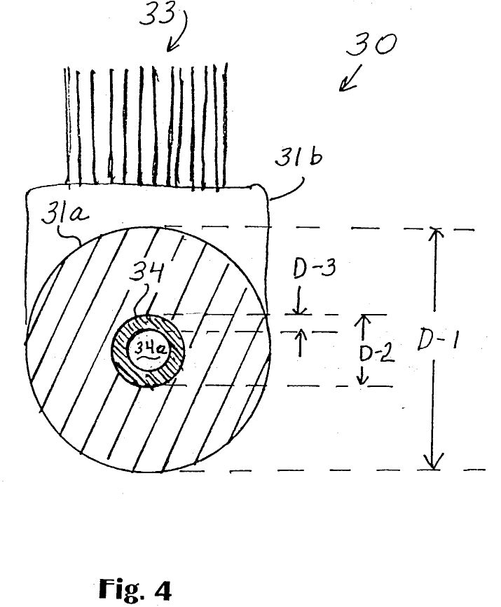

Referring now to FIGS. 3 and 4, toothbrush 30 includes a body 31 having an proximal elongated handle portion 31a and a distal head portion 31b to which bristles 33 are attached. The body 31 is fabricated from a non-meltable material such as soft rubber or a paper-containing material (e.g., rolled paper, papier-mache, etc.). Sufficient stiffness to brush one's teeth is provided by a tubular spine 34 of a material such as fiberglass or graphite composite. Alternatively, spine 34 can be fabricated from an engineering plastic such as polyimide, polyetheretherketone (“PEEK”), polycarbonate, acrylics, and the like. Also, spine 34 can alternatively be fabricated from a rolled paper or cardboard.

Referring particularly now to FIG. 4, the proximal handle portion 31a of the toothbrush 30 has a diameter D-1, as indicated above, typically ranging from about 3/8 inches to about 1.0 inch. Spine 34 preferably has an outer diameter D-2 ranging from about 0.125 inches to about 0.350 inches, more preferably from about 0.24 inches to about 0.26 inches. The tubular spine 34 has an inner surface defining an axial bore 34a and a wall thickness D-3 of from about 0.005 inches to about 0.050 inches. These dimensions are given for the purpose of exemplification. Other dimensions can be used when appropriate. The dimensions and materials are selected so as to provide sufficient strength for the intended purpose of brushing one's teeth, but which would not provide strength for use as a thrusting weapon, or for supporting a blade in a carved out notch. Moreover, the non-meltable material of construction cannot be reformed or remolded, and it will not take an edge by attempted grinding or sharpening.

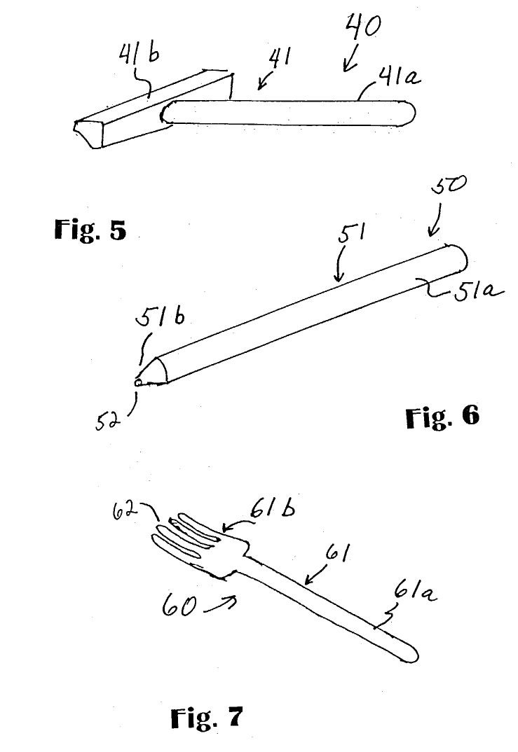

As stated above, the present invention can be associated with various hand held implements. For example, FIG. 5 illustrates a safety razor 40 fabricated in accordance with the invention. Safety razor 40 includes a body 41 of non-reformable material and construction as described above. Body 41 includes a proximal elongated handle portion 41a and a distal operational portion 41b to which a razor blade is mounted for the purpose of shaving. FIG. 6 illustrates a writing implement 50 fabricated in accordance with the invention. Writing implement 50 includes a body 51 of non-reformable material and construction as described above. Body 51 includes a proximal elongated handle portion 51a and a distal operational portion 51b to which a nib 52 is mounted for the purpose of applying ink to a writing surface. FIG. 7 illustrates an eating utensil, fork 60, fabricated in accordance with the invention. Fork 60 includes a body 61 of non-reformable material and construction as described above. Body 61 includes a proximal elongated handle portion 61a and a distal operational portion 61b to which tines 62 are mounted for the purpose of grasping food.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. An implement comprising:
a body having a proximal handle portion and a distal operational portion, the body being non-sharpenable and fabricated from a non-meltable material, and having frangible means for limiting body strength by facilitating structural failure of the body upon application thereto of a force exceeding a predetermined magnitude.

2. The implement of claim 1 wherein the non-meltable material is a thermoset resin.

3. The implement of claim 2 wherein the thermoset resin is a polymeric resin selected from the group consisting of epoxy, melamine, phenolic, urea-formaldehyde resin phenol-formaldehyde resin, polyurethane, polyimide, polyurea, butadiene polymer, silicone polymer, allyl resins and unsaturated polyesters.

4. The implement of claim 1 wherein the non-meltable material is a paper-containing material.

5. The implement of claim 1 wherein the distal operational portion supports bristles.

6. The implement of claim 5 wherein the implement is a toothbrush.

7. The implement of claim 1 wherein the distal operational portion supports a razor blade.

8. The implement of claim 7 wherein the implement is a shaving implement.

9. The implement of claim 1 wherein the implement is a writing implement.

10. The implement of claim 1 wherein the implement is an eating implement.

11. The implement of claim 1 wherein the proximal handle portion includes an outer wall portion defining an interior space.

12. The implement of claim 11 wherein the interior space contains particles.

13. The implement of claim 12 wherein the interior space is under a vacuum.

14. The implement of claim 11 wherein the interior space contains a fluid.

15. The implement of claim 14 wherein the fluid is under pressure.

16. The implement of claim 1 wherein the body contains particles of a filler.

17. The implement of claim 1 wherein the body includes a tubular spine of relatively more rigid material extending axially therethrough.

18. The implement of claim 17 wherein the tubular spine is fabricated from a material selected from the group consisting of fiberglass, graphite composite or paper.

19. The implement of claim 18 wherein the body is fabricated from soft rubber or papercontaining material.

20. The implement of claim 19 wherein the paper containing material is papier-mache.
